(19) United States
(12) Patent Application Publication
(10) Pub. No.: US 2009/0317533 A1
(43) Pub. Date: Dec. 24, 2009

(54) METHOD FOR PRODUCING A SOY MILK

(75) Inventor: Martin Herrmann, Wunsdorf (DE)

Correspondence Address: BARNES & THORNBURG LLP, 750-17TH STREET NW, SUITE 900, WASHINGTON, DC, 20006-4675, US

(73) Assignee: Westfalia Separator AG, Oeide (DE)

(21) Appl. No.: 12/294,752

(22) PCT Filed: Mar. 27, 2007
(86) PCT No.: PCT/EP2007/052944

§ 371 Date: Jan. 14, 2009

(30) Foreign Application Priority Data
Mar. 29, 2006 (DE) 102006014781.2

(51) Int. Cl. A23C 11/00; A23L 1/20; A23C 11/10

(52) U.S. Cl. 426/598; 426/634; 426/488; 426/476; 426/460; 426/518; 426/489; 426/507; 426/482; 426/656

(57) ABSTRACT

A method of production of a soymilk or a soy-based beverage. The method includes the following processing steps: providing soybeans for processing; soaking the soybeans; grinding the soybeans to form a slurry; separating the soy slurry into soymilk and okara in a centrifugal field. The soaking and grinding are carried out at temperatures from 0° C. to 40° C., which temperatures yield native proteins. Further included is a step of deodorizing the soymilk to reduce the beany taste.

### CROSS-REFERENCE TO RELATED APPLICATIONS

This application is a National Phase Application based upon and claiming the benefit of priority of PCT/EP2007/052944, filed on Mar. 27, 2007 and of German Application No. 10 2006 014 781.2, filed on Mar. 29, 2006, the contents of these Applications being hereby incorporated herein by reference.

### BACKGROUND AND SUMMARY

The present disclosure relates to a method of production of a soymilk.

In particular, the present disclosure relates to a method of production of a soymilk in which, in qualitative organoleptic terms, a better product is produced and/or a product with an improved yield with respect to the protein content of the soybeans. In addition, using the method according to the present disclosure, it is possible to obtain native proteins having beneficial effects in further processing to tofu and other protein-containing products.

Concerning the technological background, reference is made to the following literature: Tofu & Soymilk Production, 2nd edition, Shurtleff & Aoyagi, ISBN 0-933332-14-9 (C) (1984); Handbuch der Milch- und Molkereitechnik (Manual of milk and dairy technology) 2nd edition, Herrmann et al. ISBN 3-7862-9071-8 (2000); Lebensmittel- und Bioverfahrenstechnik—Molkereitechnologie (Food technology and biotechnology—Dairy technology), Kessler H. G, Verlag A. Kessler, Postbox 1538, D-8050 Freising (1988) and Industrieprojekt GEA Wiegand GmbH, D-76275 Ettlingen, Eindampftechnik (Evaporation technology) (2005).

A generic method is known from SHURTLEFF W. et al.: The Book of Tofu (1984) Chapter 5: Principles of Tofu and Soymilk Production, p. 115-131. In this method, soybeans are first soaked for some hours, for example, more than six hours, with water that is approximately at the temperature of the surrounding air, that is, for example, somewhat cooler in summer and somewhat warmer in winter and are then ground. The soy liquor obtained by cold extraction is separated into soymilk and okara. After this separation, the soymilk is heated. It is also stated in the text that by using water with a higher temperature, for example, 55° C., the soaking time need only be 1 to 2 hours.

FR 2 578 396 proposes soaking soybeans for 6 to 12 hours in water with a temperature of 15° C. to 30° C., grinding them and separating into two phases.

US 2006/0062890 A1 proposes soaking soybeans in degassed water at 4° C., grinding them and then separating the slurry into okara and water by filtration.

In U.S. Pat. No. 3,728,327, the soybeans are soaked, homogenized and then separated into soymilk and okara in a centrifuge. The protein contained in the soymilk is concentrated further by reverse osmosis.

In EP 0 883 997 A1, to obtain native protein, soybeans are soaked in warm water at 5° for 20 hours and are then submitted to a separation step for removing the soymilk. The soymilk is not intended for consumption but for further processing to obtain various valuable products.

From the Asiatic region, the production of a milk from soybeans for the production of a drinkable product, such as soymilk, and for processing of the soymilk to tofu, concentrates, isolates and similar products is also known, which uses the following process stages: the soybeans are soaked for a period of 16-24 hours with cold water, at temperatures around 25-20° C.; then the soaking water is discarded and then extremely fine grinding is carried out, with addition of water; and, this soy mash is heated to temperatures of 90 to 95° C., held at this temperature for varying lengths of time, and separated by sieving into soymilk and solid matter, such as okara. The soymilk is used for human consumption as a beverage or for further processing to tofu. Okara is a by-product used for animal feed.

Methods are also known in which, after cold soaking for up to 24 hours, the beans are ground at temperatures of 20-30° C. This is followed by heating to about 95° C., to inactivate the enzyme lipoxygenase. This enzyme is responsible for the development of an undesirable beany taste. Furthermore, heating is necessary for inactivating trypsin inhibitors.

Methods have recently been developed that make a continuous process possible and give a higher protein yield than the traditional methods. In particular, the “Vita Soy, Bühler and Cornell” methods are mentioned.

Adapted to the state of the art, the process can be described as follows.

Soybeans are treated with water at about 90° C. to 95° C. for 5-15 minutes, though sometimes this soaking time can be omitted. Then hot grinding is carried out. A two-stage grinding process is followed by heating to inactivate the enzymes, such as lipoxygenase and trypsin inhibitors, and then separation in a decanter at temperatures between 80 and 90° C. The resultant okara is mixed once again with hot water. Next, a second decanting is carried out at these temperatures to improve the yield. Then the soymilk resulting after the second decanting is mixed with the soymilk from the first decanter and deodorization is carried out. Said deodorization comprises heating to temperatures of 95-145° C. followed by sudden expansion in vacuum vessels. This removes undesirable flavoring matter, for formation of which lipoxygenase is responsible, and at the same time the trypsin inhibitors can sometimes also be inactivated. This heating can also take place before decanting. After that, the product is stored hot or cold, prior to sterile filling via a UHT heating system or utilization for tofu production.

Basically, in connection with these methods, it should be pointed out that in the known methods of production of soymilk, denaturation of the native proteins takes place, and optimal reduction of the beany taste is not achieved in the stated deodorization step.

To improve the yield, during the grinding process the pH value of the solution is raised above pH 7.0, mainly with sodium bicarbonate, which improves the solubility of the proteins. Mainly on health grounds, this is followed in the storage tank by adjustment of the pH to below pH 7.0 with an organic acid, and addition of the acid causes local overacidification of the product resulting in partial precipitation of proteins.

Against this background, the present disclosure relates to a method that, while retaining a continuous process, an optimal soymilk or a soy or soy-based beverage is obtained, which has improved properties for further processing to soy products.

The present disclosure relates to a method of production of a soymilk or a soy-based beverage. The product is obtained by the following processing steps:

providing soybeans for processing;

soaking of the soybeans;

grinding the soybeans to form a slurry;

separation of the soy slurry into soymilk and okara in a centrifugal field;

wherein the soaking and grinding are carried out at temperatures from 0° C. to 40° C., which temperatures are suitable for obtaining native proteins; and

deodorizing the soymilk to reduce a beany taste.

The soybeans may be soaked and ground at temperatures from, for example, 2° C. to 40° C., or 2 to 20° C.

It may be advantageous for the soybeans to be soaked continuously.

The soybeans may be soaked and ground with degassed water and/or ice water.

It may be advantageous for the soybeans to be soaked for a period of, for example, less than 60 min, or for a period of less than 30 min.

The okara obtained from the method can be mixed with water and/or with soymilk.

The okara mixed with water and/or with soymilk can additionally be submitted to further intensive mixing.

The intensive mixing may be carried out, for example, using a colloid mill or an emulsifying apparatus.

It may be advantageous if the separation of the soy slurry into soymilk and okara in the centrifugal field is carried out with a separator and/or a solid-wall helical conveyor centrifuge.

Throughout the process up to deodorization for the production of a soymilk, temperatures are kept, for example, below 90° C., or below 70° C., or below 40° C.

Deodorization is carried out by a thermal method, in such a way that the beany taste is reduced while maintaining temperatures from 98° C. to 103° C. under atmospheric pressure.

Deodorization may be, moreover, carried out by an evaporation process.

Deodorization may be carried out in a dearomatization unit.

According to another embodiment of the present disclosure, heating before deodorization may be by live steam, or with live steam suitable for food processing.

According to another embodiment of the present disclosure, the heating with live steam is preceded by a preheating by a heat exchanger.

The preheating may be, for example, carried out to 45° C., or to 50° C.

According to another embodiment of the present disclosure, heating of the soymilk with live steam is carried out for a period of less than 180 s, or less than 120 s or less than 60 s.

The soymilk is heated with live steam up to a temperature of max. 110° to 140° C., or up to 110° C. to 130° C. or up to 120° C. to 125° C.

Deodorization, moreover, may be carried out by an evaporation process, in which the volumes of steam are at least 1.5 kg steam/kg product. It is desirable, during deodorization, to carry out heating to a temperature of max 110° C. to 140° C., or up to 110° C. to 130° C. or up to 120° C. to 125° C. first, and then cooling to 85° C.

It may also be advantageous if, during deodorization, expansion is carried out in the evaporator system to 45° C., or possibly to 40° C.

According to another embodiment of the present disclosure, the expansion is carried out in a falling-film evaporator.

According to another embodiment of the present disclosure, during the expansion from the higher temperature to the low temperature, a nebulization takes place through a sprinkler-like feed head into a vacuum vessel, wherein the product to be degassed does not or substantially does not come into contact with contact surfaces.

It may be further desirable if the soymilk is submitted to UHT, ultra high temperature, heating, in which it is homogenized in the nonaseptic range.

The UHT heating at pressures of more than 200 bar and in subsequent direct UHT heating, a cavitation effect is produced, which leads to comminution of fat globules.

According to the present disclosure, it is conceivable for single-stage or two-stage homogenization to be carried out.

It may be advantageous if the soymilk obtained is dried by a spray tower at product temperatures below the denaturation of soy proteins.

Product temperatures below 80° C. may be used during spray drying.

Cold soaking or deodorization are of course already known. What has not been recognized previously, however, is the especially advantageous combination of soaking with cold water of the stated temperature range, for only a short period, subsequent separation into soymilk and okara and deodorization. This should be done under the boundary conditions, as disclosed herein, by which a marked reduction of the beany taste and a good protein content in the soymilk are achieved simultaneously. Soymilk means a soy-based beverage.

Using a method of dearomatization, such as in a falling-film evaporator, undesirable odorous substances and flavoring matter are eliminated.

Moreover, with the processing steps and temperatures according to the methods of the present disclosure, native proteins can be obtained, which are suitable for further processing to tofu and other protein-containing products. It must additionally be regarded as beneficial that the soymilk produced according to the present disclosure has a greatly reduced beany taste. The beany taste is undesirable in many regions.

According to another embodiment of the method according of the present disclosure, it is possible, using ultrafiltration or other methods of separation, to produce native protein, offering the possibility of optimized technology for the production of soy-protein concentrates and/or isolates and other protein products.

With the method according to the present disclosure, it is also possible to obtain a soy powder with a high proportion of undenatured protein. In such a case, for example in spray drying in the temperature range 180-200° C. drying temperature, a product temperature of 70 to 80° C. is reached, at which the native proteins that are present are not denatured. In this way it is possible to obtain a Low Heat soy powder or a Medium Heat soy powder with specific functional properties. Depending on product heating, there is either slight, or low-heat, or medium denaturation of the proteins of 40-60%, or medium-heat.

To extend the shelf life of the soymilk, it can be heat-treated with a direct UHT heating process. This uses a direct UHT heating unit, in which homogenization takes place in the aseptic range, as a result of comminution of the fat globules.

Such a plant design was adopted by the dairy industry for the sterilization of milk for human consumption. With such a processing step, in addition to sterilization, there is a considerable time delay in creaming of the milk fat. In this comminution, the milk fat globules are reduced in size from an average diameter of approx. 20 μm to an average diameter of 1-3 μm. Further comminution is not carried out, as otherwise the oil separates from the fat, which would produce an oil-containing layer on cow's milk for human consumption. This method uses pressures of up to 200 bar, with a two-stage homogenization being carried out in the dairy industry, first at about 200 bar and then at ⅓ to ¼ of the aforementioned principal pressure.

This two-stage homogenization is advantageous because with single-stage homogenization at, for example, 200 bar, in milk for human consumption that has been treated and packaged in this way, agglomerates are formed from the milk fat globules. These agglomerates can have a size range of up to 400 μm. At this size range there would be considerable creaming of the fat in the milk and a layer of fat would form in the milk for human consumption. In two-stage homogenization in the dairy industry followed by a homogenization stage of about 70 bar, these agglomerates are broken up, so that there is reduced creaming. No separation of oil from the product occurs.

With a sterilized soymilk there is still the problem with the fat globules, in that there is a creaming tendency during storage. This can be seen from the fact that, depending on the storage time, fat flocs, or fat-protein agglomerates, appear on the surface of the packaged sterilized soymilk, which are undesirable.

It is to be borne in mind that in this method steam is injected into the product during direct heating. This produces a cavitation effect, which corresponds to homogenization of about 70 bar. The method of direct UHT heating in the dairy industry comprises first steam injection, then expansion with subsequent two-stage homogenization at the aforementioned pressures. If, during direct UHT treatment of milk, homogenization were to take place before heating, the result would be thinning of the fat globules, leading to separation of oil. It should be noted that in the case of cow's milk for human consumption, the homogenization after the UHT treatment must take place in the sterile range. This means that a homogenizer of aseptic design is required, and sterile operation thereof must always be guaranteed.

In the treatment of soymilk, it was found in the experiments or tests performed that comminution of the fat globules prior to direct UHT heating in two-stage homogenization is advantageous. As a result, the already size-reduced fat globules are further comminuted by the cavitation effect in direct UHT heating, though in contrast to cow's milk for human consumption, no oil separation effect occurred and the aforementioned formation of fat flocs was not observed.

Another advantage of the method according to the present disclosure is that a homogenizer of sterile design is not required, which offers cost advantages, and not only in terms of capital expenditure.

In experiments or tests performed, according to the present disclosure, no oil separation effects were found.

The soymilk or soy basis is excellent for use in the production of tofu, protein concentrates, protein isolates and similar products, as well as in the production of low-heat and medium-heat soy powder.

The method, according to the present disclosure, of production of a soymilk with an improved protein yield comprises some or all of the steps disclosed herein, in which the temperatures employed are below the denaturation temperature of the soy proteins. Native proteins can be obtained that are of interest, owing to their functional properties, for further processing to tofu, protein concentrates, protein isolates and similar products such as soy powder. By combining various processing steps, in accordance with present disclosure, in which the resultant soy mash is treated, not only for reasons of taste, at temperatures below the denaturation temperature of soy protein, an improved yield can be obtained with simultaneous improvement of color.

Moreover, the use of a concentration system for deodorization using live steam can improve the taste of the end product.

Other aspects of the present disclosure will become apparent from the following descriptions when considered in conjunction with the accompanying drawings.

### BRIEF DESCRIPTION OF THE DRAWINGS

FIG. 1a shows a first part of a flow chart of a first method, according to the present disclosure.

FIG. 1b shows the second part of the flow chart of the first method, according to the present disclosure.

FIG. 2 shows a flow chart of a second method, according to the present disclosure.

FIGS. 3 and 4 are schematic representations of sections of an extruder for use in the second method shown in FIG. 2.

FIG. 5 is a table of data relating to the second method shown in FIG. 2

### DETAILED DESCRIPTION

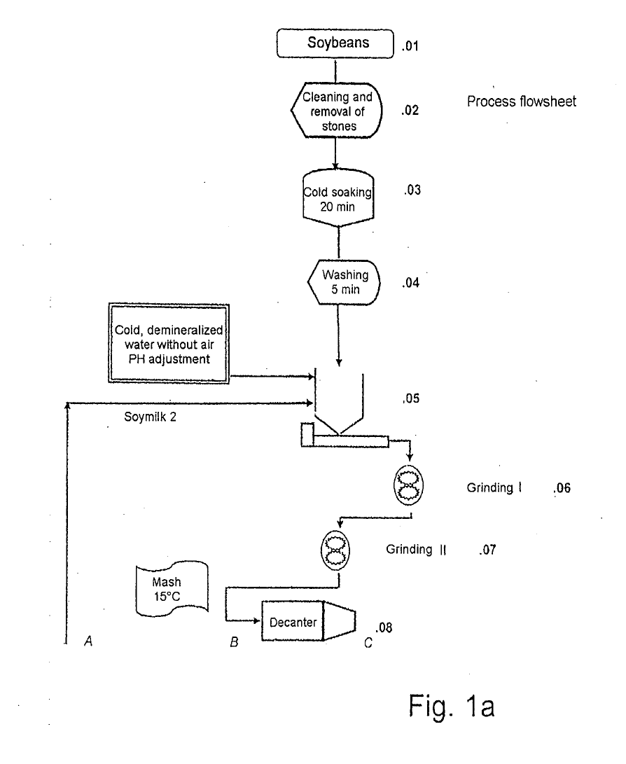

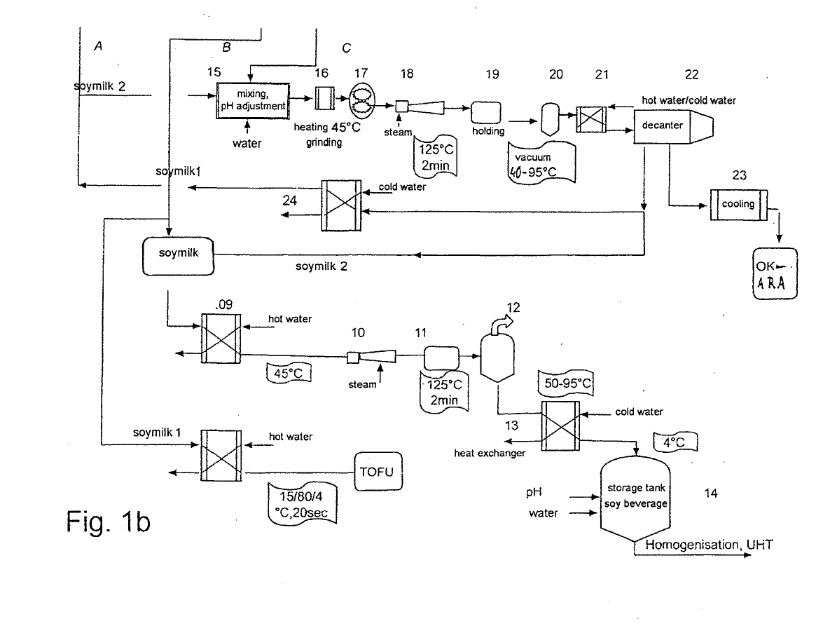

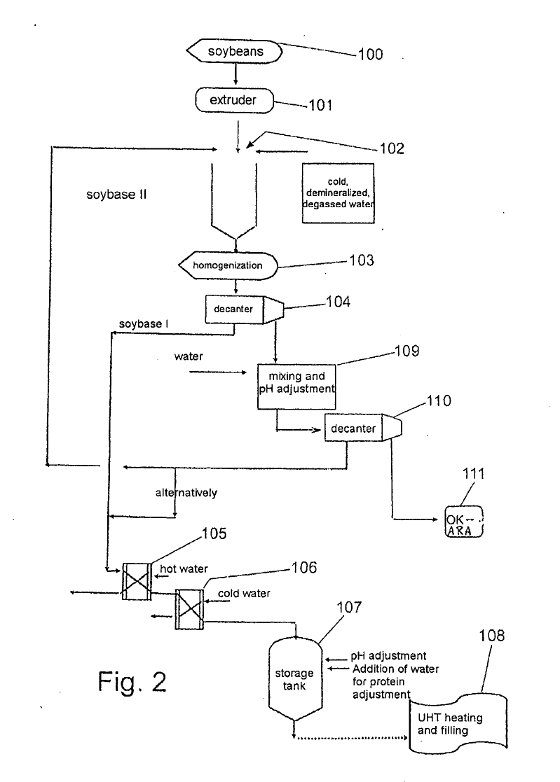

In FIGS. 1a and 1b, the processing steps are labeled A, B and C. The individual process steps have been numbered to make this process flowsheet easier to understand. The process steps thus are identified by number and may be shown in this text in parentheses to avoid confusion or may be shown without parentheses where the identification is clear.

On delivery, soybeans (0.01) are cleaned in a mechanical unit, and undesirable adhering particles such as lumps of earth and stones or other foreign matter are removed (0.02). The soybeans (0.01) are soaked in a continuous process with cold water (0.03), to optimize the grinding process. After this soaking process, the soybeans (0.01) are washed (0.04). The soaking and washing remove undesirable flavoring matter from the soybeans (0.01) and reduce activation of lipoxygenase, or beany taste. The wash water is discarded.

After this cleaning and soaking the beans are submitted, with cold and, for example, demineralized water (0.01), to two grinding stages. At the same time, the pH value of this mixture of beans and water is adjusted to above 7.0, in order to improve the protein yield. Simultaneously, an already treated soymilk is, for example, added to the water/beans mixture to provide a liquid/beans mixture that is optimal for grinding (0.05).

This water/soymilk/beans mixture, with a temperature of approx. 15° C., is ground using a perforated-disk mill (0.06) and a colloid mill (0.07) and is decanted at the approximate 15° C. temperature (0.08). Two components are now obtained: a soymilk I, labelled as B and okara I, or soybean residues labelled as C.

A further treatment of the okara I is described later herein.

The soymilk I obtained from the decanter (0.08) is preheated, for energy reasons, to 45° C. (0.09) and heated with live steam (10) at 125° C. for 2 minutes and held at this temperature for 2 min (11).

This heating is carried out in order to inactivate the lipoxygenase, whose activity is responsible for the negatively perceived beany taste. Then the product goes to a special dearomatization unit (12), which operates similarly to an evaporation system, except that it removes undesirable odorous substances and flavoring matter from the soymilk. This vacuum treatment takes place at temperatures up to 50° C. Then the product is cooled with ice water (13) to 4° C. and is stored in a tank (14). In this storage tank, the protein content is adjusted to a desired final protein content of the end product and the pH is corrected for organoleptic reasons. Flavoring to vanilla or cocoa can also be carried out in this storage tank, prior to product heating and filling.

The okara obtained from the first decanter (0.08) is utilized as follows for improving the protein yield.

The okara I is mixed with water (15) and, if necessary, is again adjusted to a desired pH value. The mixture is heated to 45° C. (16) and then undergoes homogeneous mixing in another processing step, that is, in an additional grinding stage (17). Heating can also be carried out prior to grinding. In this way, what is achieved is further extraction of native protein from the cell structure of the soybeans that were already ground in steps (0.06) and (0.07). Next, this product is heated with live steam (18), for example, to 125° C., in order to achieve sufficient inactivation of the lipoxygenase in a holding time of 2 minutes (19). This heating additionally has the purpose of preventing multiplication of microorganisms during this process.

The heated product is cooled to a temperature of approx. 40-95° C. (20) and optionally its temperature is adjusted further, possibly via a heat exchanger 21. Depending on the initial temperature, operating with cold or hot water, separating in a 2nd decanting stage (22) into soymilk 2 and okara I can take place.

This okara I can be cooled (23) and sent for further processing/use. The soymilk 2 is cooled (24) and used as a partial stream mainly during grinding of the cleaned and soaked beans (0.05).

This soymilk 2 can, however, also be added directly to the okara I from the first decanting stage (15). This results in an increase in protein yield.

In the processing of soybeans it is, moreover, of interest to obtain native proteins for the production of tofu and other products, for example, soy protein concentrates and similar products. In such a case it is desirable to make use of the interesting functional properties of the soy proteins that are in the form of native proteins, as opposed to denatured proteins. In order to obtain native proteins, heating above the denaturation temperature of the proteins must be excluded. This is accomplished in the process of single-stage decanting, but in this, only a protein yield of the order of 60% can be achieved.

If the second decanting (22) takes place without the heat treatment, an increase in yield on the protein side by a further 15% is realistic. This employs the process path of (0.08) via process steps 15, 16, 17, 18, 19, 20 and 21 without temperature increase, or process steps 17, 18, 19, 20 and 21 are omitted.

For microbiological reasons it may nevertheless be of interest to use the process steps 16, 17, 18, 19 and 20, because in this circuit (0.05), (0.06), (0.07), (0.08), 15, 16, 17, 18, 19, 20, 21, 22 and 24 there may be enrichment of microorganisms and increased lipoxygenase activity. This problem can be solved with brief heating below the denaturation temperature of the soy protein to 100° C. by components 16, 18, 19 and 20.

In such a case it is reasonable to use the heat exchanger (21), for suitable adjustment of product temperature depending on the intended use. For example, decanting is carried out at 10-30° C. Furthermore, using heat exchanger (21), it is possible for decanting to be carried out in the temperature range between 10 and 30° C. and in the range between 70 and 95° C.

The problems of lipoxygenase are to be regarded as secondary in the production of a soymilk for the production of, for example, tofu and other products in which whey is formed. During precipitation of the soy protein, the undesirable odorous substances and flavoring matter arising during the lipoxygenase transformations are transferred to the whey and are largely absent from the end product.

For microbiological reasons, for this product group brief heating is carried out, for example, at temperatures between 71 and 80° C. for a period of 45 to 12 seconds, which almost excludes denaturation of the soy protein.

In the process, according to the present disclosure, there is neither heat treatment nor pH correction for the preparation of soymilk for tofu and other products. This can be seen from the following process sequence:

cold soaking (ice water, demineralized as far as possible);

cold grinding;

cold decanting;

A temperature can be maintained, for example, below 70° C., which may be below 40° C. (see soymilk I in FIGS. 1a and 1b).

According to the prior art, beans are soaked at 15 to 25° C., until they absorb water in the ratio of beans to water of 1 to 2.2 or 1 to 2.5. This soaking process comprises a discontinuous operating mode, as it requires times of 8 to 24 hours.

For a continuous operating mode, a far shorter soaking time would be required, or the soaking process might be omitted.

The method according to the present disclosure comprises a soaking time of up to 30 minutes, which in contrast to the known methods can be designed as a continuous process. It is known that as a result of soaking there is a decrease in dry matter, caused by the transfer of carbohydrates to the wash water. This process is desirable, as it also leads to a slight improvement of taste of the soymilk.

There is also an improvement in protein solubility, which is a valuable precondition of the functional properties of proteins.

Furthermore, from the standpoint of process engineering parameters, it is of interest to achieve uptake of water by the beans during cold grinding, as this allows or facilitates the grinding process with a perforated-disk mill and colloid mill.

Tests showed that even a slight uptake of water by the beans has a beneficial effect. This uptake of water can be seen from the following test:

Beans wetted with water

| | Weight of the beans in kg |
|---|---|
| Residence time in the water bath at 25° C. | |
| 0 min | 100 |
| 10 min | 128 |
| 20 min | 138 |
| 30 min | 142 |
| 60 min | 156 |
| 7 h | 186 |
| 24 h | 233 |
| Residence time in the water bath at 8° C. | |
| 0 min | 100 |
| 10 min | 123 |
| 20 min | 127 |
| 30 min | 130 |
| 60 min | 143 |
| 7 h | 187 |
| 24 h | 221 |

The resultant uptake of water in a time of 5 to 40 min, or, for example, 10 to 30 min, is sufficient to permit trouble-free grinding in a perforated-disk mill and a colloid mill.

Without soaking, the mills would be loaded excessively, and clogging of the mills can also occur.

Moreover, in this method, according to the present disclosure, the temperature of the soaking water was reduced to 2 to 5° C. As a result, activity of lipoxygenase is largely excluded. In the subsequent process steps, the temperature was lowered to the stated range, to obtain, along with native proteins, a product with beany taste virtually absent. The uptake of water achieved is to be regarded as sufficient.

The method or methods as described herein and according to the present disclosure, may include additional processing steps.

In the method described above, according to the present disclosure, because of the single decanting in the cold state, optimization of protein yield is not provided. Therefore, water was added to the okara I obtained after the first decanter (0.08) and it was adjusted to the known pH value above 7.0 to improve the yield, though this pH adjustment can also be omitted. In one test at temperatures of 2 to 30° C., the resultant product was decanted using a decanter, or a solid-wall helical conveyor centrifuge. In another test, this rediluted okara I is heated in another heating stage and is fed at high temperatures to the second subsequent decanter (22).

In these tests, a soy mash was investigated for the protein yield in different processing steps.

As starting material, a soy mash was used in which the soybeans had a protein content of 39.9%. These were ground as follows: at temperatures of about 20° C.; and at temperatures of about 90° C.

This soy mash was decanted at “cold” temperatures, for example, 25-30° C. and at “hot” temperatures of about 90° C. The resultant okara, in tests IV, V, VI, VII and VIII, (see below) was mixed with water or water and soymilk and once again decanted “hot” or “cold” in a second stage.

The reason for using soymilk from the first decanter was to show whether this is sensible on process engineering grounds, without a substantial drop in yield.

The test arrangements were as follows:

Test I: cold grinding-cold decanting;
Test II: cold grinding-hot decanting;
Test III: hot grinding-hot decanting;
Test IV: okara from test I;
Test IVa: dilution of okara with water only and cold decanting;
Test IVb: dilution of okara with soymilk I and water and cold decanting;
Test V: okara from test II;
Test Va: dilution of okara with water only and hot decanting;
Test Vb: dilution of okara with soymilk II and water and hot decanting;
Test VI: okara from test III;
Test VIa: dilution of okara with water only and hot decanting; and
Test VIb: dilution of okara with soymilk III and water and hot decanting.

Evaluation of these tests showed the following yields (see next table). The yields are calculated, on the one hand, with the protein content determined in the soymilk and, on the other hand, with the protein content in the okara obtained. It has to be borne in mind that the yields determined for the “okara” are subject to errors. It was very difficult to determine the resultant amounts of okara at outlet from the decanter, so that the tests with the calculation “soymilk” were relevant. However, for the sake of completeness, the results with the “okara” are also shown.

| | Yield calculated for | | |
|---|---|---|---|
| | Okara | Soymilk | Color |
| Test I: Cold grinding - cold decanting | 56.73 | 68.40 | 6.50 |
| Test II: Cold grinding - hot decanting | 72.25 | 72.21 | 5.00 |
| Test III: Hot grinding - hot decanting | 61.06 | 68.55 | 7.00 |
| Test IV, okara from Test I | | | |
| IVa: Dilution with water only | 75.46 | 87.31 | 9.00 |
| IVb: Dilution with soymilk I + water | 70.40 | 67.79 | 8.50 |
| Test V, okara from Test II | | | |
| Va: Dilution with water only | 84.91 | 82.31 | 6.50 |
| Vb: Dilution with soymilk I + water | 82.79 | 76.70 | 6.00 |
| Test VI, okara from Test III | | | |
| VIa: Dilution with water only | 75.22 | 82.92 | 8.50 |
| VIb: Dilution with soymilk I + water | 71.42 | 78.82 | 8.00 |

For a further improvement in yield the okara mixed with water was dispersed in a colloid mill, to achieve further washing-out of protein from the disrupted cells.

The test setup was as follows:
Test VII: Cold grinding-cold decanting
Dilution of okara from test I with water
Dispersion-decanting, second stage “cold”
Test VIII: Hot grinding-hot decanting
Dilution of okara from test III with water
Dispersion-decanting “hot”

The results achieved are presented in the following table.

| | Yield calculated for | | |
|---|---|---|---|
| | Okara | Soymilk | Color |
| Test VII: Cold grinding - cold decanting | | | |
| Dilution of okara from test I with water | 81.58 | 90.45 | 9.00 |
| Dispersion - Decanting | | | |
| Test VIII: Hot grinding - hot decanting | | | |
| Dilution of okara from test III with water | 72.05 | 86.01 | 8.00 |
| Dispersion - Decanting | | | |

The tests showed that:

in single-stage decanting of a soy mash, protein yields of 62 to 72% were achieved. In this case the soy mash supplied (cold and hot ground) was decanted cold and hot; with dilution of the okara with water and soymilk, protein yields of 69 to 80%; and with dilution of the okara with water only, protein yields of 79 to 84% were achieved.

The best results, also taking into account the color of the soymilk obtained, were achieved in tests VII, IVa, VIa and VIII. This comprises, in the case of cold grinding of the beans, decanting twice with redilution of the okara with water, cold or hot decanting in the 2nd stage with additional treatment of the rediluted okara in a colloid mill.

Regarding assessment of the color of the soymilk obtained, it should be pointed out that the assessment was carried out according to the “Karlsruhe Test Scheme”. That is, score 9 best color, score 1 very poor color, with corresponding gradations therebetween.

The process, according to the present disclosure, can also be designed so that heating is carried out on, the one hand, for protein yield, and, on the other hand, for inactivation of trypsin inhibitors. With such a heating stage, protein yield optimization is achieved, and these combined processing steps, that is, native protein/denatured protein, must be viewed in relation to one another. The second heating can take place in a plate-and-tube heat exchanger. However, heating by direct steam injection is advantageous, as this leads to effective inactivation of lipoxygenase.

For heat-engineering reasons, the steam injection can also include preheating to 50° C. in a heat exchanger.

Heating with live steam, for example, to 140° C. is carried out in the existing methods. The milk heated in this way is fed to a vacuuming vessel of simple design, immediate cooling to 90° C. taking place using vacuum. This vacuum treatment includes a desired partial dearomatization.

In the method according to the present disclosure, the soymilk obtained from decanter A or B, is for example, preheated in a plate heat exchanger and heated with live steam, for example, to 125° C. or to 140° C., and for inactivation of lipoxygenase there should be time/temperature correlation similar to an F-value calculation of up to Fo-value=30. The Fo-value is an index for heating for killing microorganisms. At an Fo-value of 10 it can be assumed that all relevant germs in the product have been killed.

This heating can take place in a nozzle system with direct steam injection in a tubular system, with external cooling of its surface.

Then an extremely gentle dearomatization is carried out with cooling to 90° C. to 40° C. in a falling-film evaporator, a system for achieving a large surface, with the result that in the falling-film evaporator of a far larger surface with extended lifetimes. For example, the liquid undergoing dearomatization is fed onto heating tubes, and runs down as a thin film on the inside walls.

As a result of external heating of the tubes, the liquid film begins to boil and partially evaporate, giving a continuously slow evaporation process. Undesirable odorous substances and flavoring matter are eliminated, for example, an undesirable beany taste is barely or no longer perceptible in the end product. This leads to a qualitative advantage with respect to taste compared with the methods known to date. However, other dearomatization plants can also be used.

In the known methods described until now, a direct UHT heating unit is used with homogenization in the sterile range. As the proportion of emulsifier in soymilk is considerably higher than, for example, in cow's milk for human consumption, homogenization in the aseptic range can be omitted. In the method according to the present disclosure, homogenization takes place in the nonsterile range before the actual UHT heating. This gives an advantage in terms of plant costs, as the homogenization unit does not have to be of sterile design.

The method, according to the present disclosure that is described above is considered to be advantageous compared to known methods.

The first method described above, according to the present disclosure, includes an important aspect which is the deodorization. During comminution of the soybeans, the lipoxygenase is activated, its inactivation temperature being above 80° C. It must be borne in mind that the transformations caused by the enzyme activity increase at higher temperatures and this leads to a beany taste. This taste, which is perceived as negative, consists partly of volatile components, which can mostly be removed from the soymilk by deodorization.

The method, according to the present disclosure, relates among other things, to a process to prevent, at least to a large extent, the development of a beany taste.

The present disclosure relates to a method of production of a soymilk, wherein the soybeans are ground by extruder technology to obtain native proteins and to improve the taste, so that the comminution of the soybeans already takes place in the extruder.

The present disclosure relates to a method of production of a soymilk in which soybeans that have not been soaked are ground directly by the extruder technology.

For example, the soybeans ground by the extruder technology are mixed with water, so that a slurry is formed.

It is desirable if the soybeans ground by the extruder technology are mixed with water, and then this mixture is separated into soymilk and okara.

In addition, the extruder processing is carried out in such a way that only slight denaturation of the proteins occurs.

Using the extruder technology, the beany taste can be reduced.

The temperature settings in the extruder are, for example, such that at least inactivation of 90% of the lipoxygenase is provided.

In addition, moreover, with temperatures in the extruder from 100° C. to 150° C., conveying elements, among others, are used, which make possible a return-conveying effect for a longer residence time in the extruder.

The comminution of the beans takes place by extrusion in the extruder at over 90° C.

The processing in the extruder may take place, for example, at 90-140° C., in order to obtain a high proportion of undenatured proteins.

It is desirable if, by return-conveying screw elements, maximum possible inactivation of the lipoxygenase takes place, while maintaining a high proportion of native proteins.

Extraction of the proteins may take place by the processing steps of soaking, mixing, homogenizing.

Comminution by homogenization can be single-stage and two-stage.

It is also conceivable, according to the present disclosure, that comminution of the extruded product takes place by cavitation.

In addition, to improve the yield on the protein side, the pH is raised to around pH 9.

Furthermore, for organoleptic reasons, neutralization to a pH value of 6.5 takes place.

It is also conceivable according to the present disclosure that, prior to comminution, inactivation of the soybeans in the noncomminuted state is carried out by a steam hulling process.

By using the extruder technology, comminution of the beans is achieved which, owing to its low thermal load, offers the possibility of obtaining native proteins without a beany taste.

With the extruder processing, in the production of mainly native proteins there is an improvement in taste and color.

By the extruder technology, sufficient inactivation of the lipoxygenase is also achieved in a simple way for the production of pulverulent substances with a high native protein content.

By using extruder technology, comminution can be arranged so that with a very brief heating, in the region of seconds, a product is achieved, by which, with further processing in the process steps according to the present disclosure, an almost native protein is also achieved at increased yield and with a reduced beany taste.

Further tests on the improvement of taste of a soymilk showed that inactivation of lipoxygenase can already be achieved during the processing of the soybeans.

In such a case, beans with a water content around 10% were extruded at 140 to 150° C., in the region of seconds in a twin-screw extruder, with post-heating in the extruder head. In the tests performed in accordance with the present disclosure, the product was heated in the extruder to temperatures of about 130° C. and set a temperature of 150° C. before discharge from the extruder. The product obtained from the extruder had, after coarse comminution, a slightly powdery to powdery-grainy structure.

The particle size was in this case between 10 and 100 μm, or micrometers, at a relative frequency of 23% in the range between 37 and 45 μm. The distribution curve suggests, however, that in the higher range up to 100 μm they may be agglomerates.

The bulk density was 500-740 g/l depending on the processing in the extruder. The differences found in bulk density are due to the different amounts added in the process, and at the same time it was also possible to adjust the graininess of this intermediate. This product can either be ground further and/or water can be added to it and, for example, it can be processed further in a colloid mill.

Further processing of this product showed that without further grinding, the protein yield was unsatisfactory. Hot water was added to the coarse-comminuted product under pressure at 110° C. in the ratio 100 g to 1 L water, and it was cooled immediately.

Organoleptic testing showed the samples that were cooled immediately after the hot water/steam treatment did not have a beany taste. A beany taste was clearly perceptible when these samples were cooled slowly. This shows that, in the thermal treatment in an extruder, the enzyme lipoxygenase was still not sufficiently inactivated, although there was already an Fo-value=16 at 150° C. with a holding time of 1 s.

Further treatment was carried out with the method described of cold grinding, with deodorization sometimes being omitted. The soy mash achieved, with the extruder processing, lipoxygenase problems, and was almost free of any perceptible beany taste.

After decanting, using “cold treatment”, a soymilk was obtained which, owing to the low thermal load, a Q10 value, had undergone protein denaturation, which with this short temperature action is not to be regarded as relevant. This product proved especially suitable for tofu production, as it gave good strength of the end product with a corresponding light color and a good protein yield.

A starting point of the method, according to the present disclosure, is therefore the use of the extruder. It is possible, at the same time, to design the comminution of the beans and the heating of the beans in such a way that the lipoxygenase is largely inactivated.

For further extruder tests, a co-rotating twin-screw extruder was used from the company Berstorff with the designation ZE 40AX37,5DHT. The extruder has a screw diameter of 43 mm and a screw length of 1500 mm, and an 18 kW drive motor with variable speed from 15 to 300 rev/min. The configuration of the screw was chosen from the aspects of the shearing action with conveying kneading sections.

It was found that the temperatures in the extruder are important.

Tests in a temperature range of 15-50° C. in the extruder showed that the resultant soymilk had a pronounced beany taste.

Tests at 100° C., 120-C and 140-C in the extruder showed that the testers now found a considerable reduction of the beany taste in the soymilk produced in each case. Temperatures of about 120° C. in the extruder were of particular interest.

In the tests it was found that, by using back-pressure kneading sections in the extruder at a temperature around 120° C., the soymilk produced was no longer found to have a beany taste. If, however, at roughly the same temperature the back-pressure kneading sections were omitted, a beany taste of the soymilk produced was determined organoleptically. Therefore, a certain residence time in the extruder is required for inactivation of the lipoxygenase, that is, elimination of the beany taste related to a time/temperature correlation. These problems were not observed at temperatures of about 140° C.

Tests at higher temperatures, for example, above 140° C., showed decreases in yield for the resultant soymilk. Purely on the basis of visual examination, the extruded product was of a brownish color. It could, therefore, be concluded that considerable protein denaturation had taken place, and extraction of the protein from the damaged cells was only partially possible. This was also evident from the resultant soymilk. It did not have a typical white color. This soymilk was yellowish or brownish and rather transparent. Purely on the basis of this visual examination, it can be concluded that economic extraction of the protein from the extruded product had not occurred.

In further processing, for improvement of protein yield the extruded product was submitted to intensive mechanical treatment in water in the ratio of beans to water 1:9, and in other tests at 1:7. For this, a turbine mixer was used (Ultra Turrax) for a time of 5 to 15 min. Then the “water-extruded beans mixture” was homogenized at different pressures in several stages and then decanted in beakers using a centrifuge. The supernatant, the soymilk, was investigated for protein content and the protein yield was determined, relative to the protein content of the beans. Organoleptic testing for taste was carried out according to the Karlsruhe Test Scheme. The best assessment=9 and the worst assessment=0.

Among other things, the following procedure was used with related results:

| Max. | | | Protein yield | | |
|---|---|---|---|---|---|
| temp. in | | | in the | | |
| the | Homoge- | | supernatant | | |
| extruder, | nization | Pressure, | after | | |
| ° C. | stages | bar | decanting, % | Taste | Color |
| 20 | 0 | none | 86 | 3 | cloudy, milky |
| 20 | 1 | 70 | 41 | 3 | ″ |
| 20 | 2 | 200/70 | 35 | 3 | ″ |
| 100 | 0 | none | 46 | 7.5 | milky |
| 100 | 1 | 70 | 44 | 7.0 | ″ |
| 100 | 2 | 200/70 | 33 | 7.5 | ″ |
| 120 | 0 | none | 46 | 8.0 | milky |
| 120 | 1 | 70 | 50 | 7.5 | ″ |
| 120 | 2 | 200/70 | 49 | 7.5 | ″ |
| 140 | 0 | none | 43 | 7.5 | milky |
| 140 | 1 | 70 | 52 | 7.5 | ″ |
| 140 | 2 | 200/70 | 65 | 8.0 | ″ |

For evaluating the above results, it must be taken into account that centrifugation with a laboratory centrifuge does not produce the separation that can be achieved with an industrial decanter.

Other tests showed that, in a comparison between a laboratory centrifuge and a decanter, far less residue is produced with an industrial decanter, as the separated residue has a higher dry matter. As a result, there is a lower proportion of water-soluble protein in the sediment, which leads to a higher protein yield in the supernatant. Based on experience, it can be stated or estimated that with separation using an industrial decanter the protein yield in the performed tests would be 20 to 30% higher. Furthermore, it should be taken into account that, among other things, the feed rate for a decanter or a centrifuge can affect the separation phase and therefore also the proportion to be separated.

It was also shown in these tests that the extraction of the protein from the extruded product should, for example, be done with cold water. For the tests at 120° C., the taste was perfect in this test series. If extraction was carried out at temperatures of about 40° C., followed by homogenization at the same temperature, a beany taste was noticeable. This shows that at this temperature and with the chosen screw configuration, there is still residual activity of the lipoxygenase, whose negative effects can be eliminated by using cold water.

If in this method, according to the present disclosure, the appropriate temperature of, for example, 120° C., is maintained in the extruder with a corresponding screw configuration, and cold water is used for extracting the protein from the comminuted cells, from the standpoint of taste it is possible for deodorization to be omitted.

A further improvement in yield can be achieved in this method, according to the present disclosure, by adjusting the product to be decanted/separated to pH values of up to pH 9.0. However, as this produces a soapy taste in the end product, subsequent neutralization to pH values of 6.8-7.5 is recommended.

As an example, the production of a soymilk by the extruder process, according to the present disclosure, is described below.

The delivered soybeans (100) undergo extruder processing (101) directly.

This is followed by mixing with water and intensive mechanical treatment by stirring or a stirring phase with a turbine mixer (102).

Then homogenization is carried out at pressures around 200 bar 103).

Next, decanting into a solid and a liquid phase is carried out using a decanter or a separator (104).

In addition, further treatment of the liquid phase, that is the soymilk or soymilk basis may occur in further processing steps, for example, heating 105, cooling 106, interim storage in a storage tank 107 possibly pH adjustment and/or addition of water for protein adjustment, and possibly UHT heating and filling (108).

Further tests into improvement of yield were carried out by dissolving the residue (okara I) with water in the ratio of 1:4 proportion and centrifuging again (109, 110). The total protein yield could be raised considerably in this way.

Thus, optionally, after addition of water, mixing and pH adjustment (109), further soymilk can be separated from the okara I in another decanter 110.

It is recommended to recycle some of the soymilk and mix it with comminuted beans from the extruder 101 or feed this soymilk directly to the further steps 105 to 108.

This processing can be seen from the flowcharts.

In a large-scale test, water was added to extruded beans. The total amount was 400 kg.

For this, the aforementioned extruder from the company Berstorff was used with a temperature profile of max. 140 C and the following data:

| | | |
|---|---|---|
| Throughput: | 37.5 | kg/h |
| Rotary speed: | 150 | min⁻¹ |
| Spec. Degree of filling: | 0.375 | kg*min/h |
| Product quantity: | 150 | kg |

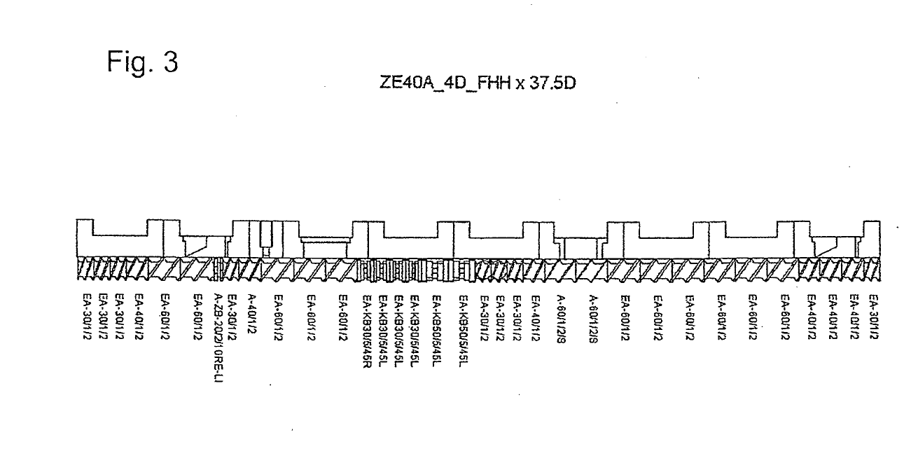

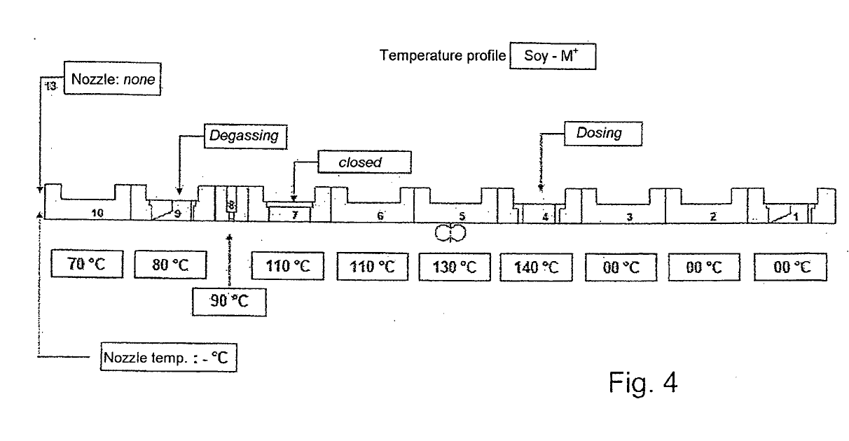

A configuration of the extruder screw is shown in FIG. 3. The associated temperature profile is shown in FIG. 4.

The soybeans were extruded, deep-frozen at −24° C. and processed after one day, storing the product for 12 hours at a temperature around 5° C. before processing.

The extruded soybeans were processed as follows:

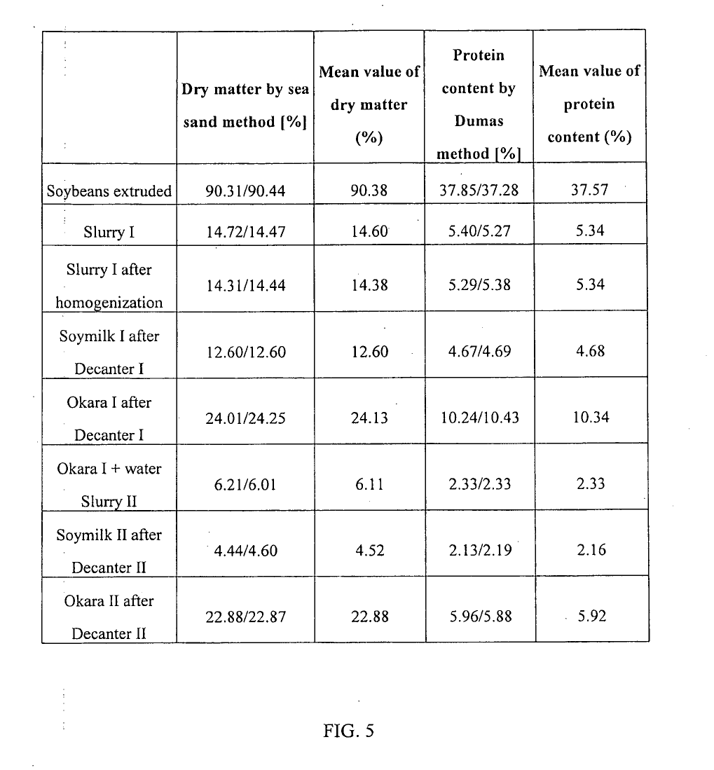

60 kg beans were mixed with 340 kg water, temperature 12.7° C.;
Mixing in the tank with a turbine mixer, 15 min (see FIG. 5-analysis Slurry I);
Homogenization at 200 bar, temperature rise to 18.7° C. (see FIG. 5-analysis Slurry I);
Decanting into 75 kg okara I and 299.5 kg soymilk basis I or soymilk I;
Mixing of 75 kg okara I with 210 kg water, temp. 13° C. (see FIG. 5-analysis Slurry II);
Homogenization at 200 bar;
Decanting into 26 kg okara II and 229 kg soymilk basis II; and
Temperature of okara II 25° C.

In this test, the first decanting resulted in okara I of 75 kg and an amount of soymilk basis of 299.5 kg.

The second decanting, in which 210 kg water was added to 75 kg, resulted in okara I of 26 kg and an amount of soymilk basis II of 229 kg, where 210 kg of cold water was added to the starting amount of okara I.

Continuous determination of performance in the second decanting showed a performance of 110.5 kg soymilk basis II and 9.5 kg okara II in 6 min, and calculation for the initial amount of 285 kg shows a proportion of okara of 22.56 kg.

Analysis of the samples for dry matter and protein gave the values in the table shown in FIG. 5.

As the losses are relatively high in such tests, only an approximate value for the protein yield can be provided. Taking into account the quantities obtained and just the determination of performance, values of 23 kg and 30 kg are determined for the resultant okara II relative to the initial amount of 60 kg.

With a quantity of soybeans used of 60 kg and a resultant proportion of okara II of 23 kg, a protein yield of 94% was achieved and okara II of 30 kg, a protein yield of 92% was achieved.

Taking into account any unrecorded losses, a safety margin of 10%, for example, should be included. Based on the assumption that this would give a proportion of okara II of 33 kg, the protein yield is 91%.

Interestingly, the soymilk basis did not have a pronounced beany taste. Furthermore, the resultant color of the soymilk basis could be described as decidedly whitish.

It should be borne in mind that the first decanter had a capacity of 600-1200 l/h. The residue achieved, of about 23%, which was determined with a laboratory centrifuge, could be further optimized for improvement of yield.

It should also be pointed out that the performance of the homogenization unit declined during comminution of the slurry. During homogenization of water it was 340 l/h, but the performance of the homogenization unit for Slurry I was 200 kg/h and for Slurry II it was 300 kg/h. As the homogenizer was used for comminution of the extruded product, because of the cavitation that occurred, this result is understandable.

The present disclosure relates to a method in which inactivation of lipoxygenase takes place before the actual processing. Using an extruder, during comminution of the beans a temperature in the extruder is chosen at which almost complete inactivation of lipoxygenase occurs. Temperatures of 100 to 140° C. are used in the extruder. The usual deodorization for the production of a soymilk, on account of the activity of lipoxygenase with respect to beany taste, is therefore no longer necessary. The same effect can also take place in a steam huller, by heating the beans suddenly under excess pressure to temperatures for inactivation of the lipoxygenase. Adjustment of pH, followed by neutralization, may be appropriate for improving the yield.

Although the present disclosure has been described and illustrated in detail, it is to be clearly understood that this is done by way of illustration and example only and is not to be taken by way of limitation. The scope of the present disclosure is to be limited only by the terms of the appended claims.

I claim:

1. A method of production of a soymilk or a soy-based beverage, comprising the following processing steps:
providing soybeans for processing;
soaking the soybeans;
grinding the soybeans to form a slurry;
separating the soy slurry into soymilk and okara in a centrifugal field;
wherein the soaking and grinding are carried out at temperatures from 0° C. to 40° C., which temperatures yield native proteins; and
deodorizing the soymilk to reduce the beany taste.

2. The method of production of a soymilk as claimed in claim 1, wherein the soaking and grinding are carried out at temperatures from 2° C. to 40° C.

3. The method of production of a soymilk as claimed in claim 1, wherein the soaking and grinding are carried out at temperatures from 2° C. to 20° C.

4. The method of production of a soymilk as claimed in claim 1, wherein the soaking is carried out in a continuous process.

5. The method of production of a soymilk as claimed in claim 1, wherein the soaking and grinding are carried out using at least one of degassed water and ice water.

6. The method as claimed in claim 1, wherein the soaking is carried out for a period of less than 60 min.

7. The method as claimed in claim 1, wherein the soaking is carried out for a period of less than 30 min.

8. The method of production of a soymilk as claimed in claim 1, wherein the okara is mixed with at least one of water and soymilk.

9. The method of production of a soymilk as claimed in claim 1, wherein the okara, when mixed with at least one of water and soymilk, is submitted to further intensive mixing.

10. The method of production of a soymilk as claimed in claim 9, wherein the intensive mixing is carried out with one of a colloid mill and an emulsifying apparatus.

11. The method of production of a soymilk as claimed in claim 1, wherein the separating of the soy slurry into soymilk and okara in the centrifugal field is carried out with at least one of a separator and a solid-wall helical conveyor centrifuge.

12. The method of production of a soymilk as claimed in claim 1, wherein temperatures below 90° C., are maintained during the soaking, grinding and separating up to the deodorizing for the production of soymilk.

13. The method of production of a soymilk as claimed in claim 1, wherein the deodorizing is carried out by a thermal process.

14. The method of production of a soymilk as claimed in claim 1, wherein the deodorizing is carried out by a thermal process, in which the beany taste is reduced, maintaining temperatures from 98° C. to 103° C. under atmospheric pressure.

15. The method of production of a soymilk as claimed in claim 1, wherein the deodorizing is carried out by an evaporation process.

16. The method of production of a soymilk as claimed in claim 1, wherein the deodorizing is carried out in a dearomatization unit.

17. The method of production of a soymilk as claimed in claim 1, further including the step of heating with live steam before deodorizing.

18. The method of production of a soymilk as claimed in claim 17, wherein the heating before deodorizing is carried out with live steam suitable for food processing.

19. The method of production of a soymilk as claimed in claim 17, wherein the heating with live steam is preceded by the step of preheating by a heat exchanger.

20. The method of production of a soymilk as claimed in claim 19, wherein preheating is carried out at a temperature of up to 45° C.

21. The method of production of a soymilk as claimed in claim 17, wherein the heating with live steam is carried out for a period of less than 180 s.

22. The method of production of a soymilk as claimed in claim 17, wherein the heating with live steam is carried out up to a temperature of max. 110° to 140° C.

23. The method of production of a soymilk as claimed in claim 1, wherein the deodorizing is carried out by an evaporation process, in which the volumes of steam are at least 1.5 kg steam/kg product.

24. The method of production of a soymilk as claimed in claim 1, wherein during the deodorizing, heating up to a temperature of max 110° C. to 140° C. is carried out first, and then cooling to 85° C.

25. The method of production of a soymilk as claimed in claim 1, wherein during the deodorizing, an expansion takes place in an evaporator system to 45° C.

26. The method of production of a soymilk as claimed in claim 25, wherein the expansion takes place in a falling-film evaporator.

27. The method of production of a soymilk as claimed in claim 1, wherein the soymilk is submitted to ultra high temperature heating.

28. The method of production of a soymilk as claimed in claim 1, wherein the soymilk is submitted to ultra high temperature heating, in which it is homogenized in the nonaseptic range.

29. The method of production of a soymilk as claimed in claim 27, wherein during the ultra high temperature heating at pressures of more than 200 bar and in a subsequent direct ultra high temperature heating, a cavitation effect is achieved, which leads to comminution of fat globules.

30. The method of production of a soymilk as claimed in claim 1, further including one of a single-stage and two-stage homogenizing step is carried out.

31. The method of production of a soymilk as claimed in claim 1, wherein the soymilk is dried by a spray tower at product temperatures below the denaturation of soy proteins.

32. The method of production of a soymilk as claimed in claim 31, wherein product temperatures below 80° C. are used in the spray drying.

33. A method of production of a soymilk, the method steps comprising:
providing soybeans to be processed; and
grinding the soybeans by an extruder to yield native proteins and to reduce a beany taste.

34. A method of production of a soymilk, the method steps comprising:
providing soybeans for processing;
grinding the soybeans in an extruder
mixing the ground soybeans with water to form a slurry,
separating the soy slurry into soymilk and okara in a centrifugal field; and
wherein the soaking and grinding are carried out at temperatures from 0° C. to 40° C., which temperatures yield native proteins.

35. The method of production of a soymilk as claimed in claim 33, further including the step of mixing the soybeans ground by the extruder with water, so that a slurry is formed.

36. The method of production of a soymilk as claimed in claim 33, further including the step of mixing, the soybeans ground by the extruder with water, which mixture is separated into soymilk and okara.

37. The method of production of a soymilk as claimed in claim 33, wherein the grinding by the extruder takes place in such a way that there is slight denaturation of the proteins.

38. The method of production of a soymilk as claimed in claim 33, wherein a comminution of the soybeans takes place in the extruder.

39. The method of production of a soymilk as claimed in claim 33, wherein the beany taste of the soymilk is reduced using the extruder.

40. The method of production of a soymilk as claimed in claim 33, wherein temperatures used in the extruder produce at least inactivation of 90% of lipoxygenase.

41. The method of production of a soymilk as claimed in claim 40, wherein, the temperatures used in the extruder are 100° C. to 150° C., and the extruder includes conveying elements, which temperatures and conveying elements permit a back-feeding effect for longer residence time in the extruder.

42. The method of production of a soymilk as claimed in claim 38, wherein the comminution of the soybeans by the extruder takes place at over 90° C.

43. The method of production of a soymilk as claimed in claim 33, wherein the grinding by the extruder takes place at 90-140° C. to provide production of a high proportion of undenatured proteins.

44. The method of production of a soymilk as claimed in claim 40, wherein by return-conveying screw elements obtain a maximum possible inactivation of the lipoxygenase while maintaining a high proportion of the native proteins.

45. The method of production of a soymilk as claimed in claim 33, wherein an extraction of the native proteins takes place by processing steps including soaking, mixing, and homogenizing.

46. The method of production of a soymilk as claimed in claim 45, wherein the homogenizing includes at least one of a single-stage and two-stage process.

47. (canceled)

48. The method of production of a soymilk as claimed in claim 38, wherein the comminution of the extruded product takes place by cavitation.

49. The method of production of a soymilk as claimed in claim 33, wherein to improve the native protein yield, a pH level is raised to a pH 9.

50. The method of production of a soymilk as claimed in claim 49, wherein for organoleptic reasons, a neutralization to a pH value of 6.5 is carried out.

51. The method of production of a soymilk as claimed in claim 44, wherein inactivation of the soybeans in a noncomminuted state is carried out by steam-hulling.

52. The method of production of a soymilk as claimed in claim 1, wherein the soymilk is used for the production of at least one of tofu, protein concentrates and protein isolates.

53. The method of production of a soymilk as claimed in claim 1, wherein temperatures below 70° C. are maintained during the soaking, grinding and separating up to the deodorizing for the production of the soymilk.

54. The method of production of a soymilk as claimed in claim 1, wherein temperatures below 40° C. are maintained during the soaking, grinding and separating up to the deodorizing for the production of the soymilk.

55. The method of production of a soymilk as claimed in claim 19, wherein preheating is carried out at a temperature of up to 50° C.

56. The method of production of a soymilk as claimed in claim 17, wherein the heating with live steam is carried out for a period of less than 120 s.

57. The method of production of a soymilk as claimed in claim 17, wherein the heating with live steam is carried out for a period of less than 60 s.

58. The method of production of a soymilk as claimed in claim 17, wherein the heating with live steam is carried out up to a temperature of max. 110° to 130° C.

59. The method of production of a soymilk as claimed in claim 17, wherein the heating with live steam is carried out up to a temperature of max. 120° to 125° C.

60. The method of production of a soymilk as claimed in claim 1, wherein during the deodorizing, heating up to a temperature of max 110° C. to 130° C. is carried out first, and then cooling to 85° C.

61. The method of production of a soymilk as claimed in claim 1, wherein during the deodorizing, heating up to a temperature of max 120° C. to 125° C. is carried out first, and then cooling to 85° C.

62. The method of production of a soymilk as claimed in claim 1, wherein during the deodorizing, an expansion takes place in an evaporator system to 40° C.
